(19) United States
(12) Patent Application Publication
(10) Pub. No.: US 2024/0235635 A1
(43) Pub. Date: Jul. 11, 2024

(54) RECONFIGURABLE DEVICE INFLUENCING RADIO WAVE SPATIAL PROPERTIES

(71) Applicant: Sony Group Corporation, Tokyo (JP)

(72) Inventors: Ying ZHINONG, Lund (SE); Kun ZHAO, Malmö (SE); Erik BENGTSSON, Eslöv (SE); Olof ZANDER, Södra Sandby (SE); Fredrik RUSEK, Eslöv (SE); Jose FLORDELIS, Lund (SE)

(21) Appl. No.: 18/563,895

(22) PCT Filed: May 11, 2022
(86) PCT No.: PCT/EP2022/062773

§ 371 Date: Nov. 23, 2023

(30) Foreign Application Priority Data
Jun. 1, 2021 (SE) 2150695-1

(51) Int. Cl. H04B 7/06

(52) U.S. Cl. CPC H04B 7/0617

(57) ABSTRACT

A reconfigurable device for influencing spatial properties of an incident radio wave comprises a first sheet having characteristics that vary along a first length direction of the first sheet, the characteristics relating to a first influencing of a spatial propagation of an incident radio wave, and a second sheet having characteristics that vary along a second length direction of the second sheet, the characteristics relating to a second influencing of a spatial propagation of an incident radio wave. A first actuator is coupled to the first sheet and configured to move the first sheet along the first length direction so as to selectively place a section of the first sheet in an exposed area of the reconfigurable device. A second actuator is coupled to the second sheet and configured to move the second sheet along the second length direction so as to selectively place a section of the second sheet in the exposed area. The first sheet and the second sheet are stacked so that a radio wave incident on the exposed area passes through the respective section of the first sheet placed in the exposed area and is incident upon the respective section of the second sheet placed in the exposed area.

### TECHNICAL FIELD

Various examples generally relate to a reconfigurable device for influencing spatial properties of an incident radio wave, wireless communication systems including a reconfigurable device for influencing spatial properties of an incident radio wave, and a method of operating a reconfigurable device for influencing spatial properties of an incident radio wave.

### BACKGROUND

In wireless communications, a demand for increasing coverage and increasing data rates may be met by use of high transmission frequencies. For example, 5G and future 6G communications systems may use a high frequency spectrum in a range of several GHz, up to THz. However, transmissions in high frequency spectra may require beamforming to overcome link budget issues and may require a line of sight (LOS) transmission. In this context, techniques involving a reconfigurable reflective device (RRD) may be considered for circumventing obstacles in line of sight transmissions and supporting beamforming.

A first kind of RRD is a reflecting large intelligent surface (LIS), reflecting intelligent surface (RIS) or intelligent reflecting surface (IRS). See, e.g., Sha Hu, Fredrik Rusek, and Ove Edfors. “Beyond massive MIMO: The potential of data transmission with large intelligent surfaces.” IEEE Transactions on Signal Processing 66.10 (2018): 2746-2758. An LIS can be implemented by an array of antennas that reflect incident electromagnetic waves/signals. The array of antennas can be semi-passive. Semi-passive can correspond to a scenario in which the antennas do not provide signal amplification, but can impose a variable amplitude and/or phase shift. An input spatial direction from which incident signals on a data carrier are accepted and an output spatial direction into which the incident signals are reflected can be re-configured, for example by changing a phase relationship between the antennas.

A second kind of RRD is a so-called smart repeater having an amplify-and-forward functionality. Amplify-and-forward functionality is different to a decode-and-forward functionality in that it is not required to translate radio frequency (RF) signals into the baseband and decode. This simplifies the hardware design of smart repeaters when compared to decode-and-forward relays. On the other hand, noise superimposed on the signal is also amplified and forwarded.

For example, an RRD may comprise an array of RRD cells, each of which may comprise one or more of the antennas and may independently incur some change to an incident signal. In general, the change incurred by the RRD may be about the phase, amplitude, frequency and/or polarization. Each or at least several of the RRD cells may comprise controllable components such as switches, electric or electronic components or mechanical driving elements for controlling reflective characteristics of the RRD cells. “Passive” changes, for example a phase shift to the incident signal, may require no transmit power. Thus, an RRD intelligently configures the wireless communication to help the transmissions between sender and receiver, when a direct communication has poor quality. An RRD may be placed at walls, building facades and ceilings.

It has been found that implementing and controlling a large amount of controllable RRD cells in an RRD may incur significant cost and extensive computational effort.

### SUMMARY

Accordingly, there is a need of improved techniques for reconfigurable devices for influencing spatial properties of an incident radio wave.

This need is met by the features of the independent claims. The features of the dependent claims define examples.

A reconfigurable device for influencing spatial properties of an incident radio wave comprises a first sheet having characteristics that vary along a first length direction of the first sheet, and a second sheet having characteristics that vary along a second length direction of the second sheet. The characteristics of the first sheet relate to a first influencing of a spatial propagation of an incident radio wave, and the characteristics of the second sheet relate to a second influencing of a spatial propagation of an incident radio wave.

A radio wave may have a propagation direction in which the radio wave propagates or it may have a direction with which the radio wave is incident on a surface or object, for example on the reconfigurable device. When influencing a spatial propagation of an incident radio wave by the reconfigurable device, this direction may be altered, for example by reflection at a certain angle of reflection or when passing through the RRD with a certain exit angle. For example, the characteristics that vary along the first length direction may be configured to influence an azimuth angle of an incident radio wave when being reflected at or passing through the reconfigurable device. The characteristics that vary along the second length direction may be configured to influence an elevation angle of the incident radio wave when being reflected at or passing through the reconfigurable device. For example, different sections of the first sheet along the first length direction may reflect an incident radio wave, or enable it to pass through, in different azimuth angles, and different sections of the second sheet along the second length direction may reflect an incident radio wave, or enable it to pass through, in different elevation angles. Varying the influence on the spatial propagation of the incident radio wave may be accomplished, for example, by varying, along the length direction of the sheet: the material of the sheet, the thickness of the sheet, patterns or combinations of different materials, passive or active electronic components, and/or antenna structures.

For example, each of the first and second sheets may comprise a plurality of static cells comprising non-controllable electrical and/or electronic components like capacitors, inductors, resistors, diodes and antenna patches. However, in other examples, each of the first and second sheets may comprise a plurality of controllable cells each comprising electronic switches, micro mechanical driving elements and/or electrical and/or electronic components like capacitors, inductors, resistors, diodes and antenna patches. Furthermore, a printed control wiring may be provided for coupling the components of the controllable cells to a control circuitry.

As a result, in particular electromagnetic characteristics of the first and second sheets may be varying along the corresponding length direction. The influence on the spatial propagation of the incident radio wave may vary gradually or continuously along the corresponding length direction.

The reconfigurable device comprises a first actuator coupled to the first sheet and configured to move the first sheet along the first length direction so as to selectively place a section of the first sheet in an exposed area of the reconfigurable device. The reconfigurable device comprises a second actuator coupled to the second sheet and configured to move the second sheet along the second length direction so as to selectively place a section of the second sheet in the exposed area. In the exposed area, the selected sections of the first sheet and the second sheet are stacked so that a radio wave incident on the exposed area passes through the respective section of the first sheet placed in the exposed area and is incident upon the respective section of the second sheet placed in the exposed area.

The second sheet may be configured such that the radio wave incident on the second sheet may pass through the second sheet also, or the second sheet may be configured such that the radio wave incident on the second sheet is reflected at the second sheet. In case the radio wave incident on the second sheet passes through the second sheet, the reconfigurable device may act as a reconfigurable transmissive device influencing spatial properties of the incident radio wave passing through the reconfigurable device. In case the radio wave incident on the second sheet is reflected at the second sheet, the reconfigurable device may act as a reconfigurable reflective device influencing spatial properties of the incident radio wave when being reflected at the reconfigurable device. In another example, the second sheet may be configured to enable the incident radio wave to pass through the sheet and the reconfigurable device comprises a reflective ground plane or reflective ground surface include an arbitrary angle.

Generally, the characteristics that vary along the first and second length direction are configured to influence the spatial propagation of the incident radio wave by refraction, diffraction or a combination thereof. For example, the characteristics that vary along the length direction of the corresponding sheet may be formed by varying a thickness of the corresponding sheet, varying an amount of a dielectric material in the corresponding sheet, varying a type of a dielectric material in the corresponding sheet, varying an amount of a conductive material in the corresponding sheet, varying a type of a conductive material in the corresponding sheet, varying a structure of a conductive material in the corresponding sheet, or a combination thereof. For example, conductive structures tuned to different resonance frequencies may be provided along the length direction of the corresponding sheet. In other examples, material with varying electric properties may be provided along the length direction of the corresponding sheet, for example by 3D printing of the electric materials on a substrate of the sheet. Varying the thickness of the corresponding sheet may include forming holes into the corresponding sheet or forming 3D structures on the corresponding sheet.

In various examples, the characteristics that vary along the first and second length directions are configured to implement a corresponding phase response and/or amplitude response for beam steering of the radio wave, for example when passing the radio wave through the corresponding sheet or when reflecting the radio wave at the corresponding sheet.

For example, the characteristics that vary along the first length direction may be configured to implement a beam steering in a first plane of incidence for the radio wave, and the characteristics that vary along the second length direction may be configured to implement a beam steering in a second plane of incidence different from the first plane of incidence. The first plane may be a horizontal plane such that an azimuth angle of the beam steering is influenced, and the second plane may be a vertical plane such that and elevation angle of the beam steering is influenced.

According to various examples, at least some sections in the first length direction of the first sheet may be configured to implement a beam steering for a portion of a radio wave having a first polarization, and to leave unaffected a remaining portion of the radio wave having a polarization different from the first polarization. Furthermore, at least some sections in the second length direction of the second sheet may be configured to implement a beam steering for a portion of the radio wave having a second polarization different from the first polarization. As a result, a polarization specific beam steering may be achieved.

In a reconfigurable transmissive device for a polarization specific beam steering, the first sheet may be configured to implement the beam steering for the portion of the radio wave having the first polarization, and the first sheet may be configured to enable the remaining portion of the radio wave having a polarization different from the first polarization to pass through the first sheet unaffected. Likewise, the second sheet may be configured to implement the beam steering for the portion of the radio wave having the second polarization, and the second sheet may be configured to enable the remaining portion of the radio wave having a polarization different from the second polarization to pass through the second sheet unaffected.

In a reconfigurable reflective device for polarization specific beam steering, at least a portion of the radio wave may be reflected at the first sheet, the second sheet and/or the reflective ground sheet if present.

For example, the first sheet may be configured to implement the beam steering for the portion of the radio wave having the first polarization, and the first sheet may be configured to enable the remaining portion of the radio wave having a polarization different from the first polarization to pass through the first sheet unaffected. The portion of the radio wave having the first polarization may be reflected according to the beam steering by the first sheet or may be beam steered toward the second sheet and may be reflected at the second sheet or the ground sheet.

The second sheet may be configured to implement the beam steering for the portion of the radio wave having the second polarization, and the second sheet may be configured to reflect the remaining portion of the radio wave having a polarization different from the second polarization, or enable it to pass through the second sheet, unaffected. The portion of the radio wave having the second polarization may be reflected according to the beam steering by the second sheet or maybe beam steered toward to the ground sheet and may be reflected at the ground sheet.

In further examples, the reconfigurable device comprises a third sheet having characteristics that vary along a third length direction of the third sheet. The characteristics that vary along the third length direction relate to a third influencing of a spatial propagation of an incident radio wave. The reconfigurable device may furthermore comprise a fourth sheet having characteristics that vary along a fourth length direction of the fourth sheet. The characteristics relate to a fourth influencing of a spatial propagation of an incident radio wave. The reconfigurable device may comprise a third actuator coupled to the third sheet and configured to move the third sheet along the third length direction so as to selectively place a section of the third sheet in the exposed area. The reconfigurable device may comprise a fourth actuator coupled to the fourth sheet and configured to move the fourth sheet along the fourth length direction so as to selectively place a section of the fourth sheet in the exposed area. The first sheet, the second sheet, the third sheet and the fourth sheet are stacked so that a radio wave incident on the exposed area passes through the respective section of the first sheet placed in the exposed area, the respective section of the second sheet placed in the exposed area, the respective section of the third sheet placed in the exposed area, and is incident upon the respective section of the fourth sheet placed in the exposed area. The radio wave incident on the respective section of the fourth sheet placed in the exposed area may be reflected at the respective section of the fourth sheet or may pass through the respective section of the fourth sheet. A ground sheet may be provided in the exposed area in a stacked manner with the first, second, third and fourth sheets such that the radio wave incident on the exposed area passes through the respective sections of the first, second, third and fourth sheets and is reflected at the ground sheet. As a result, four different beam steers may be accomplished in a reflective or transmissive way.

In the reconfigurable device with four sheets, at least some sections in the first length direction of the first sheet may be configured to implement a beam steering in a first plane of incidence for a portion of the radio wave having a first polarization and to enable a remaining portion of the radio wave having a polarization different from the first polarization to pass through unaffected. Further, at least some sections in the second length direction of the second sheet may be configured to implement a beam steering in the first plane of incidence for a portion of the radio wave having a second polarization different from the first polarization and to enable a remaining portion of the radio wave having a polarization different from the second polarization to pass through unaffected. At least some sections in the third length direction of the third sheet may be configured to implement a beam steering in a second plane of incidence different from the first plane of incidence for a portion of the radio wave having the first polarization and to enable a remaining portion of the radio wave having a polarization different from the first polarization to pass through unaffected. At least some sections in the fourth length direction of the fourth sheet may be configured to implement a beam steering in the second plane of incidence for a portion of the radio wave having the second polarization. The fourth sheet may be transmissive or reflective. A reflective ground sheet may additionally be provided in the exposed area in a stacked manner with the first, second, third and fourth sheets. The reflective ground sheet may be configured to reflect an incident radio wave that has passed through the first, second, third and fourth sheets. Each of the first, second, third and fourth sheets may be configured to reflect the portion of the radio wave that has been beam steered by the corresponding sheet or enable it to pass through.

The first, second, third and/or fourth sheets may each comprise a flexible material, preferably plastics, rubber, semiconductor material, graphene, fibers or a composition or combination thereof. The flexible material may constitute a substrate on which further materials and structures are formed providing the characteristics that vary along the corresponding length direction of the corresponding sheet. Additionally or as an alternative, the flexible material itself may provide, at least partly, the characteristics that vary along the corresponding length direction of the corresponding sheet. For example, the flexible material may have a multi-layer structure comprising some of the above-mentioned materials.

For example, each sheet may comprise several layers, for example a ground layer, a control layer, and an antenna array layer. The layers may be formed on the sheet and on each other by known technologies, for example printing, coating, deposition techniques, etching, injection molding, laser printing, vacuum metallizing, arc and flame spraying, electroless plating plastic and electroplating plastic techniques, hot dipping, brush or roll coating, and/or liquid and powder praying. The ground layer may comprise printed plastic, a metal wire grid and/or textile fibers.

According to various examples, the reconfigurable device comprises an interface for receiving control information from a network device of a wireless communication system for controlling at least one of the first, second, third and fourth actuators.

The interface may comprise a wire-based interface or a wireless interface. The control information may be indicative of the section of the corresponding sheet which is to be moved into the exposed area. In other examples, the control information may be indicative of a relative movement of the sheet to be performed by the actuator. The reconfigurable device may comprise control circuitry coupled to the interface and the actuator for controlling the actuator based on the received control information.

Additionally, or as an alternative, the reconfigurable device may comprise a wireless interface for receiving control information from a terminal device operated in a wireless communication system for controlling at least one of the first, second, third and fourth actuators. For example, the wireless interface may be configured to support a short-range wireless communication, for example a Bluetooth communication or an infrared communication. The control information may be indicative of the section of the sheet which is to be moved into the exposed area or may be indicative of a relative movement of the sheet to be performed by the actuator. Furthermore, the control information may be indicative of current receive characteristics of a transmission received at the terminal device via the reconfigurable device. The receive characteristics may comprise for example a signal strength, a signal-to-noise ratio or a frame or bit error rate. Based on the receive characteristics, the control circuitry of the reconfigurable device may reselect the section and may control the actuator to move the sheet such that the newly selected section is arranged in the exposed area. Additionally, or as an alternative, the control information may be indicative of a movement of the terminal device, which may be determined at the terminal device. Based on the movement, the control circuitry of the reconfigurable device may reselect the section and control the actuator to move the sheet so as to place the newly selected section into the exposed area.

Various examples relate to a wireless communication system comprising a network device and a reconfigurable device as described above. The network device is configured to control transmissions of an antenna arrangement of an access device of the wireless communication system. For example, the access device may comprise a base station of the wireless communication system comprising an antenna arrangement comprising a plurality of antenna elements and configured to conduct a beamforming in receive and/or transmit direction of radiofrequency signals. The network device may be a higher-level device, for example a network management device of a control plane of the wireless communication system, configured to control a plurality of access devices. In other examples, the network device may be integrated into or may be part of the access device. The network device is configured, upon a request for a transmission between the access device and a terminal device operated in the wireless communication system, to control the antenna arrangement to direct the transmission via the reconfigurable device by selecting a section in the first length direction of the first sheet and controlling the first actuator to move the first sheet such that the selected section is placed in the exposed area, and selecting a section in the second length direction of the second sheet and controlling the second actuator to move the second sheet such that the selected section is placed in the exposed area. Selecting the sections of the first and second sheets and controlling the first and second actuators to move the sheets accordingly may be an iterative process to find the optimal characteristics for influencing the spatial propagation of the incident radio wave.

A further wireless communication system comprises a network device configured to control transmissions of an antenna arrangement of an access device of the wireless communication system and a reconfigurable device as defined above. Upon a request for a transmission between the access device and a terminal device operated in the wireless communication system, the network device is configured to control the antenna arrangement to direct the transmission via the reconfigurable device. The terminal device transmits control information to the reconfigurable device upon receipt of which the reconfigurable device selects a section in the first length direction of the first sheet and controls the first actuator to move the first sheet such that the selected section is placed in the exposed area, and selects a section in the second length direction of the second sheet and controls the second actuator to move the second sheet such that the selected section is placed in the exposed area. Optionally, in case third and fourth sheets are present, in the same way a section in the third length direction of the third sheet may be selected and the third actuator controlled to move the third sheet such that the selected section is placed in the exposed area, and a section in the fourth length direction of the fourth sheet may be selected and the fourth actuator may be controlled to move the fourth sheet such that the selected section is placed in the exposed area.

For transmitting the control information to the reconfigurable device, the terminal device may utilize a Bluetooth communication or an infrared communication. The control information may comprise transmission characteristics detected by the terminal device. Based on the transmission characteristics, the reconfigurable device may select the corresponding sections of the first, second, third and/or fourth sheets to optimize transmission. Thus, the terminal device may provide a feedback to the reconfigurable device which may be used to optimize the transmission, for example by reselecting the sections in the exposed area.

A method of operating the above defined reconfigurable device in a wireless communication system comprises, upon a request for a transmission between an access device and a terminal device operated in the wireless communication system, controlling an antenna arrangement of the access device to direct the transmission to the reconfigurable device, selecting a section in the first length direction of the first sheet and controlling the first actuator to move the first sheet such that the selected section is placed in the exposed area, and selecting a section in the second length direction of the second sheet and controlling the second actuator to move the second sheet such that the selected section is placed in the exposed area.

For example, these method steps may be performed by a network device of the wireless communication system, optionally in combination with a controller of the reconfigurable device, or by the terminal device, optionally in combination with the controller of the reconfigurable device.

According to an example, the reconfigurable device may be a reconfigurable device arranged at a known position. Upon the request for transmission between the access device and the terminal device, the access device directs a radio wave to the reconfigurable device. The characteristics that vary along the first length direction of the first sheet may vary the transmission or reflection angle in the horizontal plane, i.e. the azimuth angle is varied. The characteristics that vary along the second length direction of the second sheet may vary the transmission or reflection angle in the vertical plane, i.e. the elevation angle is varied. By moving the first and second sheets, a beam sweeping in the horizontal and vertical directions may be accomplished and an area in the wireless communication system can be scanned until the influenced radio wave is appropriately directed to the terminal device. A fine tuning may be performed by varying the azimuth and elevation angles. Furthermore, upon movement of the terminal device, azimuth and elevation angles may be adjusted to keep the radio wave directed to the terminal device, for example along a direct line of sight between the reconfigurable device and the terminal device, or via reflection in an environment between the reconfigurable device and the terminal device. Further, azimuth and elevation angles may be adjusted to minimize path loss and/or maximize a signal to noise ratio (SNR) of the transmission between the access device and the terminal device via the reconfigurable device. Independent adjustment of the azimuth angle and elevation angle enables a fast and reliable readjustment, for example when the terminal device is moving or the environment that influences the propagation of the radio wave changes.

A computer program, a computer-program product, or a computer-readable storage medium includes program code. The program code can be loaded and executed by least one processor. Upon loading and executing the program code, the at least one processor performs a method of operating a reconfigurable device for influencing spatial properties of an incident radio wave in a wireless communication system.

A reconfigurable device comprises a first sheet having characteristics that vary along a first length direction of the first sheet, and a second sheet having characteristics that vary along a second length direction of the second sheet. The characteristics of the first sheet relate to a first influencing of a spatial propagation of an incident radio wave, and the characteristics of the second sheet relate to a second influencing of a spatial propagation of an incident radio wave. The reconfigurable device comprises a first actuator coupled to the first sheet and configured to move the first sheet along the first length direction so as to selectively place a section of the first sheet in an exposed area of the reconfigurable device. The reconfigurable device comprises a second actuator coupled to the second sheet and configured to move the second sheet along the second length direction so as to selectively place a section of the second sheet in the exposed area. The first sheet and the second sheet are stacked so that a radio wave incident on the exposed area passes through the respective section of the first sheet placed in the exposed area and is incident upon the respective section of the second sheet placed in the exposed area.

A method comprises, upon a request for a transmission between an access device and a terminal device operated in the wireless communication system, controlling an antenna arrangement of the access device to direct the transmission to the reconfigurable device, selecting a section in the first length direction of the first sheet and controlling the first actuator to move the first sheet such that the selected section is placed in the exposed area, and selecting a section in the second length direction of the second sheet and controlling the second actuator to move the second sheet such that the selected section is placed in the exposed area.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically shows a wireless communication system comprising a base station and a plurality of terminal devices.

FIG. 2 schematically shows a wireless communication system comprising a base station and a terminal device communicating via a reconfigurable device according to various examples.

FIG. 3 schematically shows the wireless communication system of FIG. 2 with the terminal device at another position.

FIG. 4 schematically illustrates principles of providing a varying phase offset along a radio wave influencing material according to various examples.

FIG. 5 schematically illustrates a reconfigurable device according to various examples.

FIG. 6 schematically illustrates a reconfigurable device enclosed in a housing according to various examples.

FIG. 7 schematically illustrates reflection of an incident radio wave at a reconfigurable device according to various examples.

FIG. 8 schematically illustrates reflection of an incident radio wave at a reconfigurable device according to further examples.

FIG. 9 schematically illustrates reflection of an incident radio wave at a reconfigurable device according to further examples.

FIG. 10 schematically illustrates transmission of an incident radio wave through a reconfigurable device according to various examples.

FIG. 11 schematically illustrates reflection of a radio wave in a first plane of incidence at a reconfigurable device according to various examples.

FIG. 12 schematically illustrates reflection of a radio wave in a second plane of incidence at a reconfigurable device according to various examples.

FIG. 13 schematically illustrates structures of a sheet of a reconfigurable device according to various examples.

FIG. 14 schematically illustrates a reconfigurable device according to further examples.

FIG. 15 schematically illustrates reflection of a portion of a radio wave having a first polarization at a reconfigurable device according to various examples.

FIG. 16 schematically illustrates reflection of a portion of a radio wave having a second polarization at a reconfigurable device according to various examples.

FIG. 17 schematically illustrates a reconfigurable device according to further examples.

FIG. 18 schematically illustrates reflection in a first plane of incidence of a portion of a radio wave having a first polarization at the reconfigurable device of FIG. 17.

FIG. 19 schematically illustrates reflection in a first plane of incidence of a portion of a radio wave having a second polarization at the reconfigurable device of FIG. 17.

FIG. 20 schematically illustrates reflection in a second plane of incidence of a portion of a radio wave having a first polarization at the reconfigurable device of FIG. 17.

FIG. 21 schematically illustrates reflection in a second plane of incidence of a portion of a radio wave having a second polarization at the reconfigurable device of FIG. 17.

FIG. 22 is a flowchart of a method according to various examples.

FIG. 23 is a signaling diagram according to various examples.

### DETAILED DESCRIPTION OF THE DRAWINGS

Some examples of the present disclosure generally provide a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are described that facilitate wireless communication between nodes, in particular nodes of a wireless mobile communication network system. A wireless communication system includes a transmitter node and one or more receiver nodes. The nodes communicate on a data carrier. In some examples, the wireless communication system can be implemented by a wireless communication network, e.g., a radio-access network (RAN) of a Third Generation Partnership Project (3GPP)-specified cellular network (NW). In such case, the transmitter node can be implemented by an access node such as a base station (BS) of the RAN, and the one or more receiver nodes can be implemented by wireless communication devices (also referred to as user equipment, UE, or terminal device, TD). The wireless communication devices may comprise mobile devices, for example mobile phones, smart phones, notebooks, tablet-PCs and Internet of Things (IoT) devices. It would also be possible that the transmitter node is implemented by a TD and the one or more receiver nodes are implemented by a BS and/or further TDs. Hereinafter, for the sake of simplicity, various examples will be described with respect to an example implementation of the transmitter node by a BS and the one or more receiver nodes by TDs—i.e., to downlink (DL) communication; but the respective techniques can be applied to other scenarios, e.g., uplink (UL) communication and/or sidelink communication.

According to various examples, it is possible to use multi-antenna techniques. Multi-antenna techniques are sometimes used to enhance reliability and/or throughput of wireless communication. Here, the transmitter node and the receiver node both include multiple antennas that can be operated in a phase-coherent manner. Thereby, a signal can be transmitted redundantly (diversity multi-antenna mode) along multiple spatial data streams or multiple signals can be transmitted on multiple spatial data streams (spatial multiplexing multi-antenna operational mode). It is possible to use beamforming: here, spatial data streams can be defined by focusing the transmission energy for transmitting (transmit beam, TX beam) and/or the receive sensitivity for receiving (receive beam, RX beam) to a particular spatial direction. For beamforming, the process of identifying the appropriate beams is often referred to as beam management. Various techniques described herein are concerned with beam management. According to various examples, the transmitter node can communicate with at least one of the receiver nodes via a reconfigurable device that influences spatial properties of an incident radio wave, for example changing a propagation direction of an incident radio wave. The reconfigurable device, RD, may be a reconfigurable reflective device, RRD, that may influence the spatial propagation direction when reflecting an incident radio wave, or the reconfigurable device may be a reconfigurable transmissive device, RTD, that may influence the spatial propagation direction of an incident radio wave when the radio wave is passing through the RTD. The RD may include an antenna array. The RD may include a meta-material surface. The RD may include conductive and dielectric materials. The RD may comprise structures providing refraction and/or diffraction. In examples, an RRD may include a reflective antenna array (RAA). The RD can implement a smart repeater functionality using amplify-and-forward. To forward an incident signal, the RD may not decode the signal. The RD may not translate an incident signal into the baseband. As a general rule, the RD is configured to employ multi-antenna techniques. In particular, the RD is reconfigurable to provide multiple spatial filters. Thereby, a spatial data stream between two nodes—e.g., the BS and the TD—can be diverted. Each one of the multiple spatial filters is associated with a respective input spatial direction from which incident signals on a respective data radio carrier are accepted, as well as with a respective output spatial direction into which incident signals are reflected or amplified/attenuated by the RD. Each output spatial direction is associated with a respective beam. The RD thereby may implement beamforming.

There are many approaches for how RRDs may be integrated into 3GPP-standardized RANs. In an exemplary case, the NW operator has deployed the RRDs and is therefore in full control of the RRD operations. The TDs, on the other hand, may not be aware of the presence of any RRD, at least initially, i.e., it is transparent to a TD whether it communicates directly with the BS or via an RRD. The RRD essentially functions as a coverage-extender of the BS. The BS may have established a control link with the RRD. According to another exemplary case, it might be a private user or some public entity that deploys the RRD. Further, it may be that the TD, in this case, controls RRD operations. The BS, on the other hand, may not be aware of the presence of any RRD and, moreover, may not have control over it. The TD may gain awareness of the presence of RRD by means of some short-range radio technology, such as Bluetooth, wherein Bluetooth may refer to a standard according to IEEE 802.15, or WiFi, wherein WiFi may refer to a standard according to IEEE 802.11, by virtue of which it may establish a control link with the RRD. The control link can thus be on an auxiliary carrier.

In a further exemplary case, neither the TD nor the BS are aware of the presence of the RRD. The RRD may be transparent with respect to a communication between the TD and the BS on a data carrier. The RRD may gain awareness of the TD and/or the BS and re-configure itself based on information obtained from the TD and/or BS.

The same techniques may be applied to reconfigurable transmissive devices, RTDs. Instead of reflecting an incident signal towards the TD, the RTD may redirect an incident signal towards the TD while the signal passes through the RTD.

The three exemplary cases described above are summarized in TAB. 1 below.

TABLE 1
Scenarios for RD integration into cellular NW

| Scenario | Description | Explanation |
|---|---|---|
| A | BS-RD control link | BS controls the RD and/or can obtain information |
| | | from the RD. A control link is established between |
| | | the BS and the RD. The control link can be on an |
| | | auxiliary carrier different from the data carrier. |
| | | The control link can be a wired connection, e.g., |
| | | cable or fiber. |
| B | TD-RD control link | TD controls the RD and/or can obtain information |
| | | from the RD. A control link is established between |
| | | the TD and the RD. The control link can be on an |
| | | auxiliary carrier different from the data carrier. |
| C | Transparent RD | RD re-configures itself based on information |
| | | obtained from the TD and/or BS. No control link |
| | | is established between the RD and the TD or the BS. |

According to various examples, it is possible to implement scenario A according to TAB. 1. It is optionally possible to alternatively or additionally implement the TD-RD control link according to scenario B. In any case, the RD can be fully controlled by the BS. Furthermore, it is possible to implement scenario C according to TAB. 1. RD may re-configure itself based on information obtained from the TD and/or BS, e.g. by monitoring a communication of the TD and/or BS indicating transmission signal properties, e.g. path loss or SNR, e.g. without influencing a communication protocol between BS and TD. RD may re-configure itself based on information obtained from a network server which may indirectly have access to some network configurations or signaling properties, e.g. without influencing the communication protocol between TD and BS.

In order to reflect or redirect an incident signal towards the TD, the RD may require knowledge regarding the direction and potentially distance at which the UE is positioned relatively to the RD.

The techniques described herein can be used to facilitate transmission of reference signals (RSs; sometimes also referred to as pilot signals or synchronization signals or beacon signals) transmitted by a first node, e.g., the TD. The TD can transmit the RSs in a broadcast or point-to-point manner. The RSs can have a predefined signal shape and/or symbol sequence. The RSs can have predefined transmit properties such as, e.g., transmit amplitude or phase, or even precoding. Thus, by using the RSs, one or more second nodes can obtain information on the channel between the first node and the respective one of the one or more second nodes. As a general rule, various kinds and types of RSs can be subject to the techniques described herein. For instance, RSs that are not associated with one or more specific TDs—e.g., a primary synchronization signal (PSS) or a secondary synchronization signal (SSS) broadcasted in a synchronization signal block (SSB)—can be subject to the techniques described herein. Further examples include sounding RSs and positioning RSs. Alternatively or additionally, it would be possible to apply the techniques described herein to RSs that are associated with one or more specific TDs; an example would be a Channel State Information (CSI)-RS.

To determine the direction at which the TD is positioned relative to the RD—e.g., for the purpose of beam management at the RD and/or the TD—it is possible to implement a positioning procedure between the RD and the TD. As a general rule, various options are available for implementing the positioning procedure. In particular, an RS-based positioning procedure is possible. Here, the TD transmits RSs and the RD can monitor for the RSs. Then, the RD, based on one or more receive properties of the RSs, can determine one or more characteristics of its relative position with respect to the TD. For example, the RD could determine the angle-of-arrival (AoA) of the RSs of the RS transmission; the AoA then corresponds to the direction of a spatial propagation path of signals between the TD and the RD. It would also be possible to determine the path loss to conclude on the length of the spatial propagation path. Another characteristic of the relative position would be distance. For instance, it would be possible to conclude on the distance between the TD and the RD based on a path loss experienced by the RSs of the reference-signal transmission; the path loss can be determined based on comparing a transmit amplitude of the RSs with a receive amplitude of the RSs. Another possibility to estimate the length of the spatial propagation path would be to measure the delay of signals propagating. Another option for positioning measurements includes angle-of-departure measurements at the TD, e.g., based on feedback from the RD to the TD. It is not required in all scenarios that the relative position is determined based on one or more receive properties of the RS. In some examples, the RS may also encode the position of the TD and then the RD can decode the respective digital information and compare the position of the TD with its own position; this helps to determine the AoA.

As explained above, the RD does not include the capability to demodulate RF signals to thereby facilitate baseband processing. Accordingly, in the various examples described herein, it is possible that the RD is equipped with a receiver for an auxiliary carrier that is different to the data carrier on which the RD facilitates the communication between the transmitter node and the receiver node. Then, the RS transmission can be implemented on the auxiliary carrier. In other words, based on the receiver for the auxiliary carrier, the RD can implement digital signal processing of digital signals determined based on the RSs; the RD may not have such capability for similar digital signal processing associated with transmissions on the data carrier.

For example, the data carrier and the auxiliary carrier may reside in different frequency bands. To give an example, it would be possible that the data carrier has frequencies above 20 GHz while the auxiliary carrier has frequencies below 10 GHZ, e.g., below 6 GHz. For example, typical frequencies can be in the range of 2.6 to 2.7 GHZ. Accordingly, the auxiliary carrier and the data carrier can employ different carriers. A modulation and/or coding scheme can be different for the data carrier and the auxiliary carrier. A communication protocol implemented on the data carrier can be different from a further communication protocol implemented on the auxiliary carrier. For example, the data carrier can employ a 3GPP cellular communication, while the auxiliary carrier employs a Bluetooth or Wi-Fi communication protocol.

However, in other examples, the RD may include logic to allow the RD to implement the control link within the data carrier, so-called in-band signaling. For example, a portion of the total bandwidth available at the carrier frequency can be reserved for in-band signaling. Only that portion of the bandwidth needs to be demodulated to extract the control link information. For example, an in-band receiver may be responsive to an in-band physical control channel but transparent to the (reflective) beam steering of the RD. Thus, complexity of the RD may be still kept low.

According to various examples, it is possible that the BS is in control of AoA measurements facilitated by the RD. Accordingly, the BS can orchestrate an interaction between the TD and the RD for the purpose of implementing the AoA measurements. This has the effect that, e.g., by considering ongoing AoA measurements when scheduling communication between other nodes, the BS can mitigate interference. Furthermore, control signaling overhead on the spectrum of, both, the auxiliary carrier, as well as the data carrier can be reduced by the controlled configuration of the RS transmission. It is possible to implement scenario A of TAB. 1.

Accordingly, according to various examples, the BS provides a configuration of the RS transmission to the TD. The BS may provide the configuration of the RS transmission for the purpose of facilitating the AoA measurements at the RD. Accordingly, the BS can provide the configuration of the RS transmission in response to a need to facilitate the AoA measurement at the RD based on the RSs of the RS transmission and as transmitted by the TD. The TD can then obtain the configuration of the RS transmission from the BS and subsequently transmit the RSs of the RS transmission to the RD in accordance with the configuration. Thereby, the TD can facilitate the AoA measurement at the RD. The RD can monitor for the RSs of the RS transmission and then determine an AoA, e.g., based on one or more receive properties of the RSs, e.g., amplitude and/or phase. Such monitoring can be based on at least a part of the configuration provided to the TD also being provided to the RD, from the BS. Then, the RD can implement a reconfiguration to provide a selected spatial filter of multiple available spatial filters based on the determined AoA.

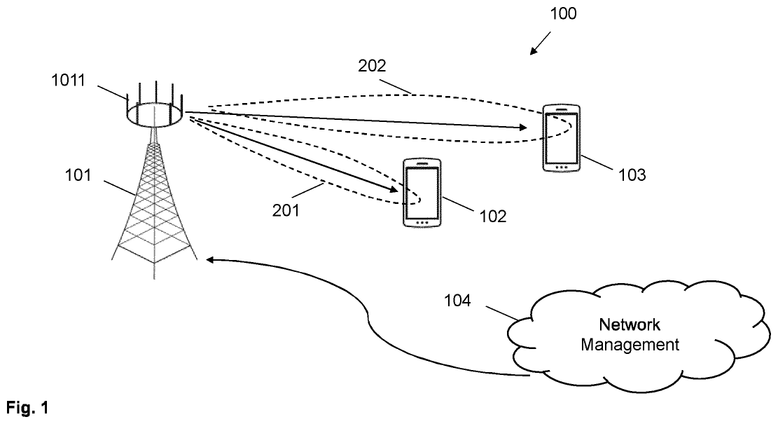

FIG. 1 schematically illustrates a communication system 100. The communication system 100 includes three nodes 101, 102 and 103 that are configured to communicate wirelessly with each other. In the example of FIG. 1, the node 101 is implemented by an access node, more specifically a BS, and the nodes 102 and 103 are implemented by terminal devices, TDs. The BS 101 can be part of a cellular NW (not shown in FIG. 1). A network management 104, for example a device or system of a control plane of the communication system 100, is coupled to the access node 101 (or access device).

As a general rule, the techniques described herein could be used for various types of communication systems, e.g., also for peer-to-peer communication, etc. For the sake of simplicity, however, hereinafter, various techniques will be described in the context of a communication system that is implemented by a BS 101 of a cellular NW and one or more TDs 102, 103.

As illustrated in FIG. 1, there can be downlink (DL) communication from the BS 101 to each of TDs 102, 103. Likewise, there can be uplink (UL) communication (not shown) from each of TDs 102, 103 to the BS 101. Various examples described herein particularly focus on the DL communication. However, similar techniques may be applied to UL communication.

The TDs 102, 103 and the BS 101 can communicate on a data carrier. For instance, the data carrier may have a carrier frequency of not less than 20 GHz or even not less than 40 GHz. The data carrier may affect carrier frequencies of up to 1 THz.

The BS 101 implements an access node to a communications network, e.g., a 3GPP-specified cellular network. The BS 101 includes control circuitry that is implemented by a processor and a non-volatile memory. The processor can load program code that is stored in the memory. The processor can then execute the program code. Executing the program code causes the processor to perform techniques as described herein, e.g. providing at least a part of a configuration for an RD (not illustrated in FIG. 1).

Each of TDs 102, 103 includes control circuitry that is implemented by a processor and a non-volatile memory. The processor can load program code that is stored in the memory. The processor can execute the program code. Executing the program code causes the processor to perform techniques as described herein, e.g. providing at least a part of a configuration for an RD (not illustrated in FIG. 1).

FIG. 1 also illustrates details with respect to communication between the BS 101 and the TDs 102, 103. The BS 101 includes an interface that can access and control multiple antennas 1011. Likewise, each TD 102, 103 may include an interface that can access and control multiple antennas.

While the scenario of FIG. 1 illustrates the antennas 1011 being coupled to the BS 101, as a general rule, it would be possible to employ transmit-receive points (TRPs) that are spaced apart from the BS.

The antenna interface of the BS 101 as well as the antenna interface of each of TDs 102, 103 can each include one or more transmit (TX) chains and one or more receiver (RX) chains. For instance, such RX chains can include low noise amplifiers, analogue to digital converters, mixers, etc. Analogue and/or digital beamforming would be possible.

Thereby, phase-coherent transmitting and/or receiving (communicating) can be implemented across the multiple antennas 1011. Thereby, the BS 101 and the TDs 102, 103 can selectively transmit on multiple TX beams (beamforming), to thereby direct energy into distinct spatial directions.

By using a TX beam, the direction of signals transmitted by a transmitter of the communication system is controlled. Energy is focused into a respective direction or even multiple directions, by phase-coherent superposition of the individual signals originating from each antenna 1011. Thereby, the spatial data stream can be directed. The spatial data streams transmitted on multiple beams can be independent, resulting in spatial multiplexing multi-antenna transmission; or dependent on each other, e.g., redundant, resulting in diversity multi-input multi-output (MIMO) transmission.

As a general rule, alternatively or additionally to such TX beams, it is possible to employ receive (RX) beams.

As an example, FIG. 1 shows a transmit beam 201 from BS 101 to TD 102 and a further transmit beam 202 from BS 101 to TD 103. Data carriers with a high carrier frequency, for example a carrier frequency above 20 GHZ, may be disturbed by obstacles in the direct line of sight between the transmit antennas and the receive antennas. Use of an RD may contribute to improve communication in case of an obstacle in the line of sight.

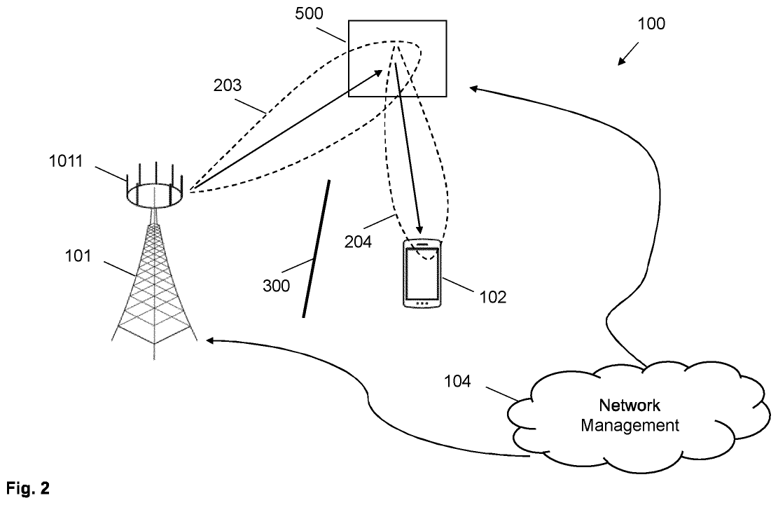

FIG. 2 shows a scenario in which an obstacle 300 at least partially blocks the direct line of sight between BS 101 and TD 102. For improving communication between BS 101 and TD 102, one or more RDs may be provided. In the example shown in FIG. 2, RD 500 is provided. In the example shown in FIG. 2, RD 500 is controlled by the network management 104. In other examples, RD 500 may be controlled by BS 101 or by TD 102. The network management 104 controls BS 101 to direct a transmit beam 203 to RD 500 which is configured by the network management 104 to reflect the incident transmit beam 203 as transmit beam 204 to TD 102.

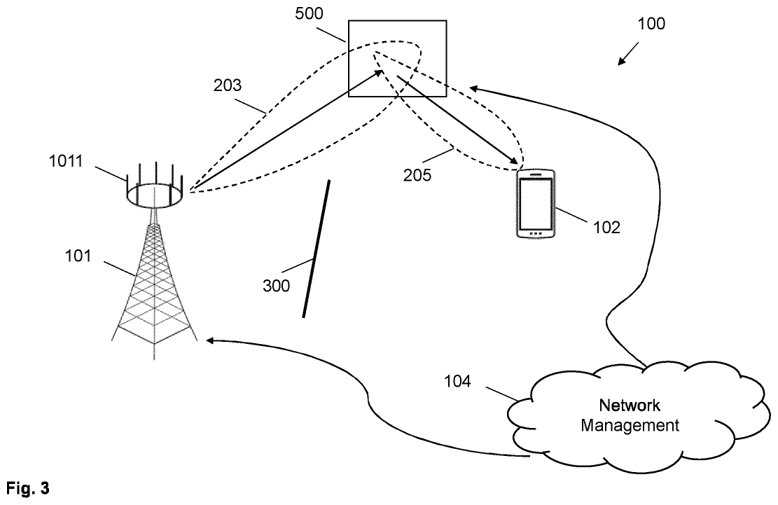

FIG. 3 shows the scenario of FIG. 2 after the TD 102 has moved. Obstacle 300 still blocks the direct line of sight between BS 101 and TD 102. The network management 104 controls BS 101 to direct a transmit beam 203 to RD 500 which is reconfigured by the network management 104 to reflect the incident transmit beam 203 as transmit beam 205 to TD 102.

RD 500 may comprise a large number of controllable cells for accomplishing the required pattern of reflection. Each controllable cell may comprise antenna patches, electronic and electrical components, switches and/or mechanical elements. In particular, for high carrier frequencies, the cells may become very small as such that implementing the switches or mechanical elements may become difficult and costly. Furthermore, controlling a large number of cells may require extensive computing power.

As an alternative, RD 500 may comprise a reflective or transmissive material that has continuously or gradually changing properties and is hinged on two rollers. A cover sheet or housing ensures that only a certain part of the material is exposed for influencing an incident radio signal. The reflection angles or exit angles can be selected by rolling the reflective material to a certain position.

In detail, at each position on the influencing material a specific phase offset that is induced whenever an incident signal is influenced at that position on the influencing material is provided. A phase offset a is equivalent to a physical distance d of additional travel distance. Therefore, the reflection or transmission at the influencing material can equivalently be seen as a reflection or refraction on a geometrical object, e.g. a reflective parabolic structure or lens. FIG. 4 illustrates a reflective parabolic structure with varying physical distances d₁ to d₁₁ of additional travel distance and an equivalent reflective material providing varying phase offsets α₁ to α₁₁. The part of the reflective material being exposed, e.g. part 400, will reflect the radio signal according to the phase offset. Different phase offsets at different locations of the influencing material provide different influences on the relationship between incident and exit angles.

However, both the incident and reflected radio signal can be characterized by two angles, e.g. their elevation angles and azimuth angles.

For example, the reflective material may be designed such that the relationship between incident and reflected elevation angles is the same at each position of the reflective material. In other words, reflections in the elevation domain cannot be controlled by moving the reflective material. Furthermore, the reflective material may be designed such that the relationship between incident and reflected azimuth angles varies along the length of the reflective material. Thus, the reflected azimuth angle can be arbitrarily controlled by moving the reflective material.

As an alternative, the reflective material may be designed such that the relationship between incident and reflected azimuth angles is the same at each position of the reflective material. In other words, reflections in the azimuth domain cannot be controlled by moving the reflective material. Furthermore, the reflective material may be designed such that the relationship between incident and reflected elevation angles varies along the length of the reflective material. Thus, the reflected elevation angle can be arbitrarily controlled by moving the reflective material.

For controlling both, azimuth and elevation angles, a reflective material of enormous length may be provided with for example a plurality of sections. Within each section the reflection properties in the elevation domain may be constant and the reflection properties in the azimuth domain may be varying over a predefined azimuth range. The sections differ from each other in that the reflection property in the elevation domain is different from section to section thus spanning a predefined elevation range. As a result, the reflective material provides each wanted combination of influence on azimuth and elevation angles at a corresponding position. However, a large length of reflective material is required and needs to be moved for positioning the needed position to the exposed position.

The same considerations can be made for transmissive materials.

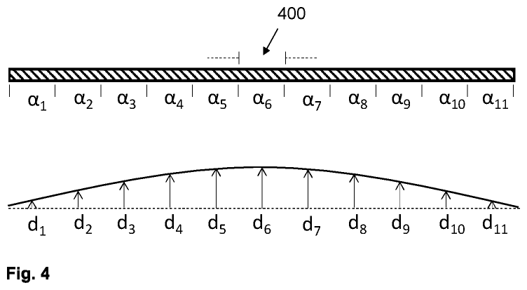

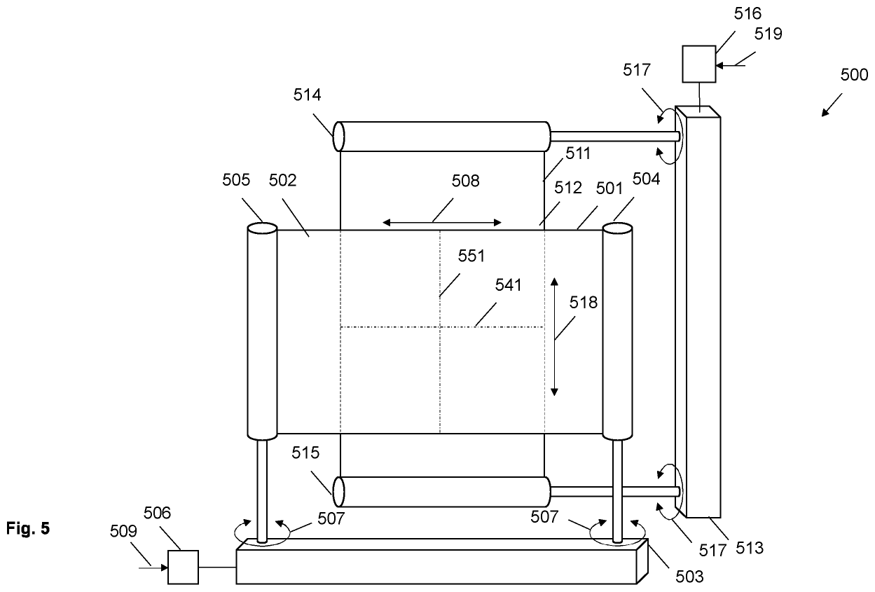

FIG. 5 schematically shows an RD 500, which may overcome at least some of the above-mentioned problems and drawbacks.

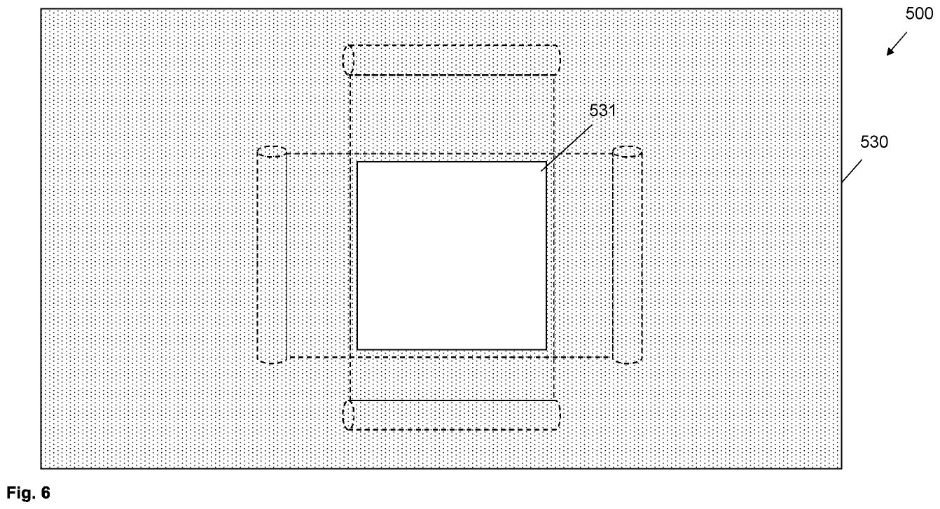

RD 500 comprises a first sheet 501 providing characteristics 502 that are varying along a first length direction 508. The characteristics 502 are configured to influence spatial properties of an incident radio wave. The first sheet 501 may have a length extending in direction 508. The RD 500 comprises a first actuator 503 coupled to the first sheet 501 and configured to move the first sheet 501 in direction 508. For example, the first actuator 503 may comprise two elongated rollers 504 and 505 which are configured to rotate in direction 507 around their longitudinal axes. The rollers 504, 505 are arranged spaced apart in parallel. Each roller has a cylindrical shape around which at least a part of the first sheet 501 may be rolled up, i.e. in a stowed position. In the area between the rollers 504, 505 a section of the first sheet 501 extends in a plane and may be exposed to incident radio waves. In the following, at least a part of the area between the rollers 504, 505 will be called “exposed area” (see also FIG. 6 and corresponding description below). The first actuator 503 may comprise a motor drive for driving the rollers 504, 505 to rotate in direction 507. By rotating the rollers 504, 505, the first sheet 501 may be moved back and forth along direction 508. The motor drive may be controlled by a controller 506. The controller 506 may comprise an interface 509 for receiving control information upon which the controller 506 controls the motor drive to place a required section of the first sheet in the exposed area between the rollers 504, 505. The interface 509 may be configured to receive the control information from for example the base station 101 or the network management 104. Additionally, or as an alternative, the interface 509 may comprise a wireless interface, for example, a Bluetooth interface or an infrared interface, which is configured to receive control information from a terminal device.

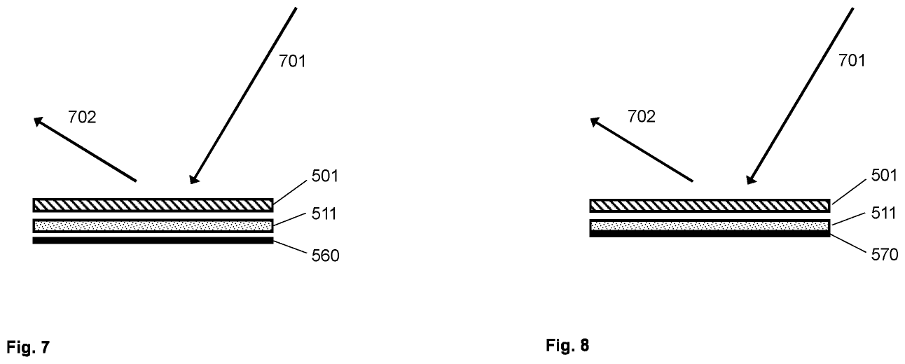

The characteristics 502 of the first sheet 501 that vary along the first length direction 508 may be configured to influence the spatial propagation of an incident radio wave in a first plane of incidence, for example in a horizontal plane, thus varying an azimuth angle of an incident radio wave. Details concerning the characteristics of the first sheet 501 will be described in more detail in connection with FIGS. 7 to 13.

Furthermore, RD 500 comprises a second sheet 511 providing characteristics 512 that are varying along a second length direction 518. The characteristics 512 are configured to influence spatial properties of an incident radio wave. The second sheet 511 may have a length extending in direction 518. The RD 500 comprises a second actuator 513 coupled to the second sheet 511 and configured to move the second sheet 511 in direction 518. For example, the second actuator 513 may comprise two elongated rollers 514 and 515 which are configured to rotate in direction 517 around their longitudinal axes. The rollers 514, 515 are arranged spaced apart in parallel. Each roller has a cylindrical shape around which at least a part of the second sheet 511 may be rolled up, i.e. in a stowed position. In the area between the rollers 514, 515 a section of the second sheet 511 extends in a plane and may be exposed to incident radio waves. In the exposed area, the exposed section of the first sheet 501 and the exposed section of the second sheet 511 are overlapping, i.e. the exposed section of the first sheet 501 and the exposed section of the second sheet 511 are stacked on each other. Stacking the exposed sections of the sheets on each other may include arranging the exposed sections “flat” on top of each other in contact or without being in contact with each other, i.e. with a gap between the stacked exposed sections. The second actuator 513 may comprise a motor drive for driving the rollers 514, 515 to rotate in direction 517. By rotating the rollers 514, 515, the second sheet 511 may be moved back and forth along direction 518. The motor drive may be controlled by a controller 516. The controller 516 may comprise an interface 519 for receiving control information upon which the controller 516 controls the motor drive to place a required section of the second sheet 511 in the exposed area between the rollers 514, 515. The interface may be configured to receive the control information from, for example, the base station 101 or the network management 104. Additionally, or as an alternative, the interface 519 may comprise a wireless interface, for example, a Bluetooth interface or an infrared interface, which is configured to receive control information from a terminal device. The controllers 506 and 516 may be constituted by the common hardware, for example, a common controller, and the interfaces 509 and 519 may be formed by a single common interface.

The characteristics 512 of the second sheet 511 that vary along the second length direction may be configured to influence the spatial propagation of an incident radio wave in a second plane of incidence, for example in a vertical plane, thus varying an elevation angle of an incident radio wave. Details concerning the characteristics of the second sheet will be described in more detail in connection with FIGS. 7 to 13.

RD 500 enables an independent adjustment of the propagation direction of an incident radio wave in azimuth and elevation domain by independently controlling the first and second sheets 501, 511. In FIG. 5, the directions 508 and 518 in which the first and second sheets are moved, are perpendicular to each other. However, directions 508 and 518 may be parallel to each other achieving the same result of independently controlling the first and second sheets 501, 511 for influencing the propagation direction of an incident radio wave in azimuth and elevation direction independently.

FIG. 6 shows the RD 500 of FIG. 5 enclosed in a housing 530. The housing 530 provides an opening or area transparent to radio waves, in which the stacked sections of the first and second sheets 501, 511 are arranged. The opening or area transparent to radio waves may be considered as the “exposed area” 531.

RD 500 may work as a reconfigurable reflective device, RRD. For example, as shown in FIG. 7, reflection may be achieved by an additional reflective ground sheet 560. FIG. 7 shows a sectional view along sectional line 541 (see FIG. 5) of the first and second sheets 501, 511 and ground sheet 560 in the exposed area 531. The ground sheet 560 may extend in a plane which is parallel to the plane of the first and second sheets 501, 511 and may have a size of at least the size of the exposed area 531. The ground sheet 560 may be arranged below the stacked first and second sheets 501, 511. The ground sheet 560 may have a surface configured to reflect an incident radio wave.

An incident radio wave 701 passes through the first sheet 501, wherein the spatial propagation properties of the radio wave are influenced by the characteristics 502 of the first sheet 501, for example an azimuth angle is modified. Next, the radio wave passes through the second sheet 511, wherein the spatial propagation properties of the radio wave are influenced by the characteristics 512 of the second sheet 511, for example an elevation angle is modified. The thus modified radio wave is reflected at the ground sheet 560 and passes through the second and first sheets 511, 501 as outgoing radio wave 702. When traveling from the ground sheet 560 through the second and first sheets 511, 501, the radio wave may be modified once more according to the characteristics of the first and second sheets 501, 511. However, characteristics of the first and second sheets 501, 511 are applied to the radio wave independently from each other and may be altered independently by moving the first and second sheets 501, 511 separately.

The portions of the first and second sheets 501, 511 which are chosen to be located in the exposed area may be selected to account for the fact that the radio wave will pass through each sheet twice.

In another example, as shown in FIG. 8, reflection may be achieved by a reflective layer 570 at the backside of the second sheet 511. FIG. 8 shows a sectional view along sectional line 541 (see FIG. 5) of the first and second sheets 501, 511 in the exposed area 531. The reflective layer 570 may be provided at the backside of the second sheet 511 along the whole back surface of the second sheet 511.

An incident radio wave 701 passes through the first sheet 501, wherein the spatial propagation properties of the radio wave are modified by the characteristics 502 of the first sheet 501, for example an azimuth angle is modified. Next, the radio wave passes through the second sheet 511, wherein the spatial propagation properties of the radio wave are modified by the characteristics of the second sheet 511, for example an elevation angle is modified. The thus modified radio wave is reflected at the reflective layer 570 and passes through the second and first sheets 511, 501 as outgoing radio wave 702. When traveling from the reflective layer 570 through the second and first sheets 511, 501, the radio wave may be modified once more according to the characteristics of the first and second sheets 501, 511. However, characteristics of the first and second sheets 501, 511 are applied to the radio wave independently from each other and may be altered independently by moving the first and second sheets 501, 511.

The portions of the first and second sheets 501, 511 which are chosen to be located in the exposed area may be selected to account for the fact that the radio wave will pass through each sheet twice.

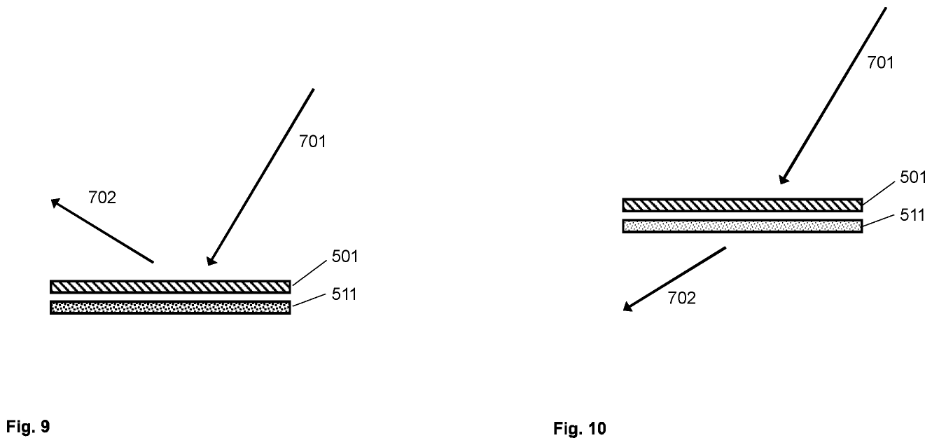

In a further example, as shown in FIG. 9, reflection may be achieved by a reflective second sheet 511, i.e. the second sheet 511 does not have transmissive characteristics as in the examples of FIG. 7 and FIG. 8, but the second sheet 511 has reflective characteristics. FIG. 9 shows a sectional view along sectional line 541 of the first and second sheets 501, 511 in the exposed area 531.

An incident radio wave 701 passes through the first sheet 501, wherein the spatial propagation properties of the radio wave are modified by the characteristics of the first sheet 501, for example an azimuth angle is modified. Next, the radio wave is reflected at the second sheet 511, wherein the spatial propagation properties of the radio wave are modified by the characteristics of the second sheet 511 when being reflected, for example an elevation angle is modified. The thus modified radio wave passes through the first sheet 501 as outgoing radio wave 702. When traveling through the first sheet 501, the radio wave may be modified once more according to the characteristics of the first sheet 501. However, characteristics of the first and second sheets 501, 511 are applied to the radio wave independently from each other and may be altered independently by moving the first and second sheets 501, 511.

The portion of the first sheet 501 which is chosen to be located in the exposed area may be selected to account for the fact that the radio wave will pass through the first sheet twice.

RD 500 may work as a reconfigurable transmissive device, RTD. FIG. 10 shows a sectional view along sectional line 541 of the first and second sheets 501, 511 in the exposed area 531. An incident radio wave 701 passes through the first sheet 501, wherein the spatial propagation properties of the radio wave are modified by the characteristics of the first sheet 501, for example an azimuth angle is modified. Next, the radio wave passes through the second sheet 511, wherein the spatial propagation properties of the radio wave are modified by the characteristics of the second sheet 511, for example an elevation angle is modified. The thus modified radio wave exits the RTD 500 as outgoing radio wave 702. Characteristics of the first and second sheets 501, 511 are applied to the radio wave independently from each other and may be altered independently by moving the first and second sheets 501, 511 separately.

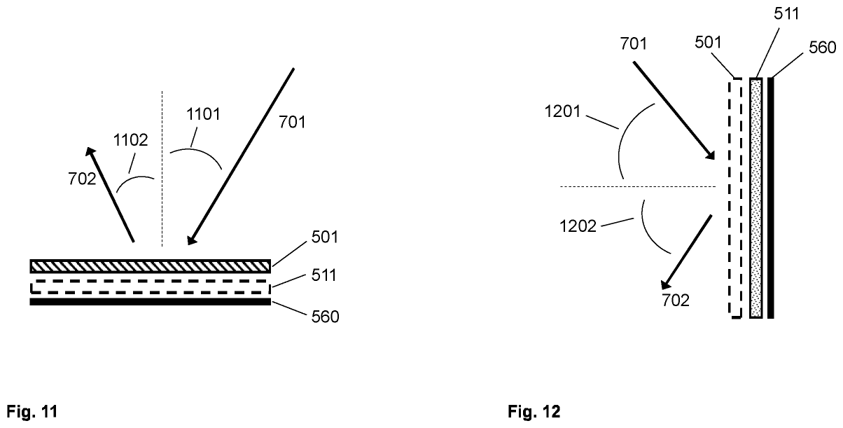

FIG. 11 and FIG. 12 illustrate principles of independently influencing spatial properties of an incident radio wave with the first and second sheets 501 and 511 of RD 500 of FIG. 5. In the example shown in FIG. 11 and FIG. 12, a reconfigurable reflective device, RRD, is assumed with the structure discussed in connection with FIG. 7. However, the illustrated principles can be applied in the same way to the structures shown in FIG. 8 and FIG. 9 and to the reconfigurable transmissive device structure shown in FIG. 10.

FIG. 11 shows a sectional view along sectional line 541 (see FIG. 5) of the first and second sheets 501, 511 and ground sheet 560 in the exposed area 531. FIG. 12 shows a sectional view along sectional line 551 (see FIG. 5) of the first and second sheets 501, 511 and ground sheet 560 in the exposed area 531.

An incident radio wave 701 has an incident azimuth angle 1101 and an incident elevation angle 1201. When passing through the first sheet 501, the spatial propagation properties of the radio wave are modified by the characteristics of the first sheet 501, i.e. the azimuth angle is modified. The second sheet 511 does not alter the spatial propagation properties of the radio wave in the azimuth domain such that the second sheet 511 is essentially transparent for the horizontal azimuth component of the radio wave (indicated by the dashed second sheet 511 in FIG. 11). Likewise, when passing through the second sheet 511, the spatial propagation properties of the radio wave are modified by the characteristics of the second sheet 511, i.e. the elevation angle is modified. The first sheet 501 does not alter the spatial propagation properties of the radio wave in the elevation domain such that the first sheet 511 is essentially transparent for the vertical elevation component of the radio wave (indicated by the dashed first sheet 501 in FIG. 12).

The thus modified radio wave is reflected at the ground sheet 560 and passes through the second and first sheets 511, 501 as outgoing radio wave 702. When traveling from the ground sheet 560 through the second and first sheets 511, 501, the radio wave may be modified once more according to the characteristics of the first and second sheets 501, 511. The outgoing radio wave 702 has an exit azimuth angle 1102 and an exit elevation angle 1202. When moving the first sheet 501 such that the characteristics vary, the exit azimuth angle 1102 changes, but the exit elevation angle 1202 remains unchanged. Vice versa, when moving the second sheet 511 such that the characteristics vary, the exit elevation angle 1202 changes, but the exit azimuth angle 1102 remains unchanged.

To sum up, a two-dimensional beam steering may be achieved. The first sheet provides the beam steering in the azimuth plane and the second sheet provides the beam steering in the elevation plane.

As an implementation detail, for example, the second sheet may change the coupling between the first sheet and the ground sheet, which creates a phase variation. Different parts of the second sheet may provide a different phase properties of the reflective signal, and by moving the second sheet, the beam steering in the elevation plane can be realized.

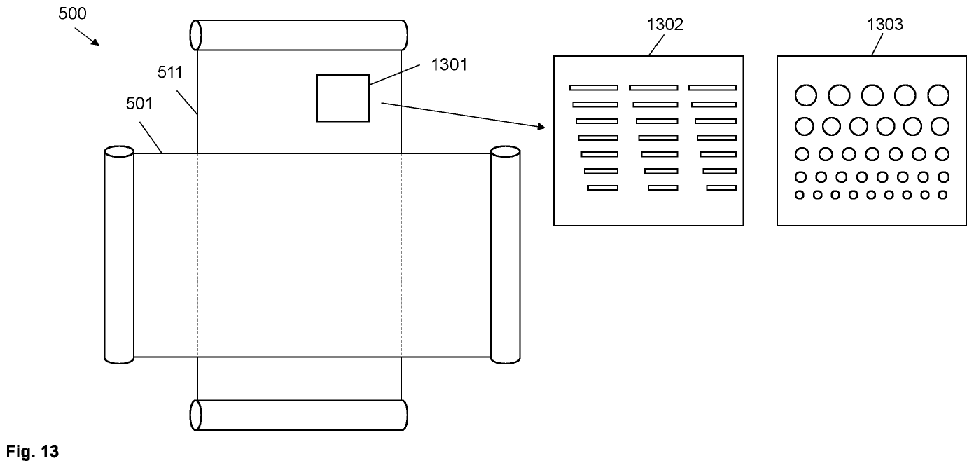

Further implementation details are shown in FIG. 13. FIG. 13 shows a first example 1302 of an enlarged view of area 1301 of the second sheet 511, and a second example 1303 of an enlarged view of area 1301 of the second sheet 511.

According to the first example 1302, the second sheet 511 may be realized by a printed metasurface with gradually changed size of unit cells along the vertical direction. Additionally, a periodicity of the features of the unit cells may gradually change along the second sheet 511. The second sheet 511 may comprise a combination and patterns of conductive and dielectric materials. The unit cell size of the second sheet 511 affects the coupling between the first sheet 501 and the ground sheet 560, which eventually changes the reflection wave phases. The unit cells may be patch-shaped or dipole-shaped or may have any other appropriate shape.

According to the second example 1303, the second sheet 511 may comprise a dielectric substrate with gradually changed effective permittivity along the vertical direction. The effective permittivity of a given substrate can be changed by varying the thickness of the substrate or providing holes or vias with different densities and diameters. The larger and denser the vias are, the lower is the effective permittivity.

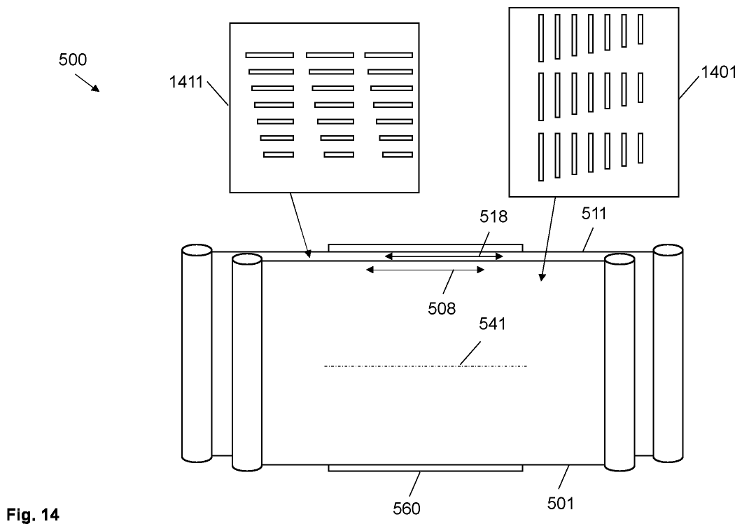

FIG. 14 illustrates a further example of an RD 500 configured to influence spatial properties of each polarization of an incident radio wave independently. In the illustrated example, a beam steering in the azimuth plane is considered only, but the same principles apply to the elevation plane, e.g. by rotating the whole arrangement by 90 degrees.

As shown in FIG. 14, a first sheet 501 movable in a first length direction 508, a second sheet 511 movable in a second length direction 518, and a ground sheet 560 are provided. In an exposed area, the first sheet 501, the second sheet 511 and the ground sheet 560 are stacked.

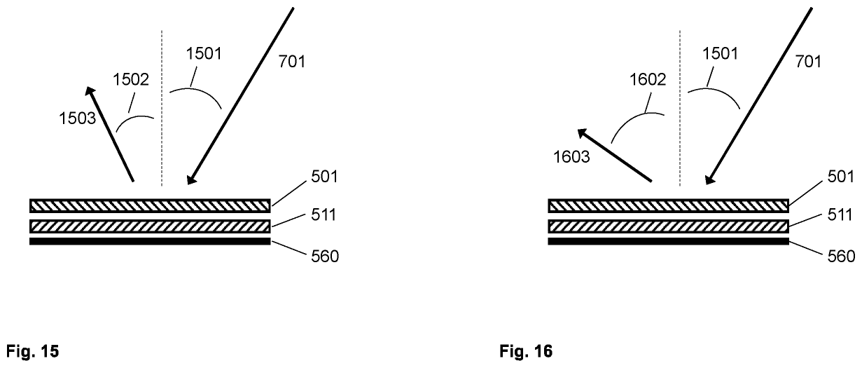

FIG. 15 and FIG. 16 show a sectional views along sectional line 541 (see FIG. 14) of the first and second sheets 501, 511 and ground sheet 560 in the exposed area.

An incident radio wave 701 has an incident azimuth angle 1501. The incident radio wave 701 may comprise components of different polarization. For example, the incident radio wave 701 may comprise a first component having a first polarization, for example a horizontal polarization, and may comprise a second component having a second polarization, for example a vertical polarization. The horizontal and vertical polarizations are examples only, and the incident radio wave 701 may comprise other kinds of polarizations, for example right circular polarization and left circular polarization. The first and second polarizations may be orthogonal to each other.

The first sheet 501 comprises a metasurface that is responsive to the first polarization only, i.e. the first sheet 501 only changes the phase of a radio wave or a component of a radio wave having the first polarization. The first sheet 501 may be transparent to radio waves or components of radio waves having other polarizations than the first polarization. The second sheet 511 comprises a metasurface that is responsive to a second polarization only.

When passing through the first sheet 501, the spatial propagation properties of the first component of the radio wave 701 are modified by the characteristics of the first sheet 501, e.g. the azimuth angle is modified according to the characteristics of the first sheet 501. The second sheet 511 does not alter the spatial propagation properties of the first component of the radio wave 701 such that the second sheet 511 is essentially transparent for the first component of the radio wave. Likewise, when passing through the second sheet 511, the spatial propagation properties of the second component of the radio wave are modified by the characteristics of the second sheet 511, i.e. the azimuth angle is modified according to the characteristics of the second sheet 511. The first sheet 501 does not alter the spatial propagation properties of the second component of the radio wave in the azimuth domain such that the first sheet 511 is essentially transparent for the first component of the radio wave.

The thus modified first and second components of the radio wave are reflected at the ground sheet 560 and pass through the second and first sheets 511, 501 as outgoing radio waves 1503 and 1603, respectively. When traveling from the ground sheet 560 through the second and first sheets 511, 501, the radio waves 1503 and 1603 may be modified once more according to the characteristics of the first and second sheets 501, 511. The outgoing radio wave 1503 has an exit azimuth angle 1502. The outgoing radio wave 1603 has an exit azimuth angle 1602. When moving the first sheet 501 such that the characteristics vary, the exit azimuth angle 1502 changes, but the exit azimuth angle 1602 remains unchanged. Vice versa, when moving the second sheet 511 such that the characteristics vary, the exit azimuth angle 1602 changes, but the exit azimuth angle 1502 remains unchanged.

As a result, when moving one of the first and second sheets, a propagation direction of only the radio wave or component of a radio wave having the polarization associated with the corresponding moving sheet will be varied.

Unit cells provided at the first and second sheets may have a good polarization selectivity to ensure the metasurface to respond to one polarization only. A dipole shape unit cell may be applied as shown in FIG. 14. For example, the first sheet 501 may comprise vertical dipoles 1401 having a varying length along the moving direction 508 of the first sheet 501. For example, a length of the vertical dipoles may vary in the range of a few millimeters, for example in the range from 2 to 5 mm. The second sheet 511 may comprise horizontal dipoles 1411 having a varying length along the moving direction 518 of the second sheet 511. For example a length of the horizontal dipoles may vary in the range of a few millimeters, for example in the range from 2 to 5 mm. The second sheet 511 may be arranged close to the ground sheet 560, e.g. at 0.25 mm above the ground sheet 650, and the first sheet 501 may be arranged close to the second sheet, e.g. at 0.5 mm above the ground sheet 560. By only changing the length of the horizontal dipoles in the exposed area, for example in the range of 2.6 to 3.4 mm, while keeping the vertical dipole length constant, for example at a length of 3 mm, essentially only the phase of the horizontally polarized radio wave is altered, and the phase of the vertically polarized radio wave is almost untouched.

The exemplary RDs 500 discussed above in connection with FIG. 5 and FIG. 14 only consider either beam steering in different planes, e.g. azimuth and elevation planes, or polarization dependent beam steering in a single plane, e.g. in the azimuth plane. In some applications, a polarization dependent beam steering in different planes may be desirable.

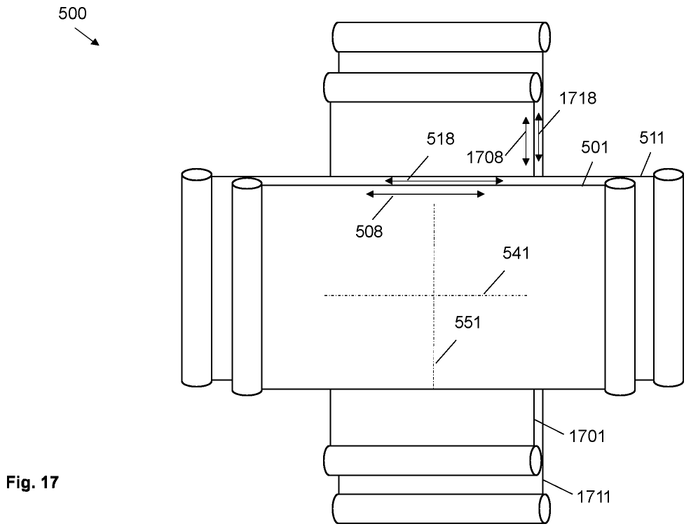

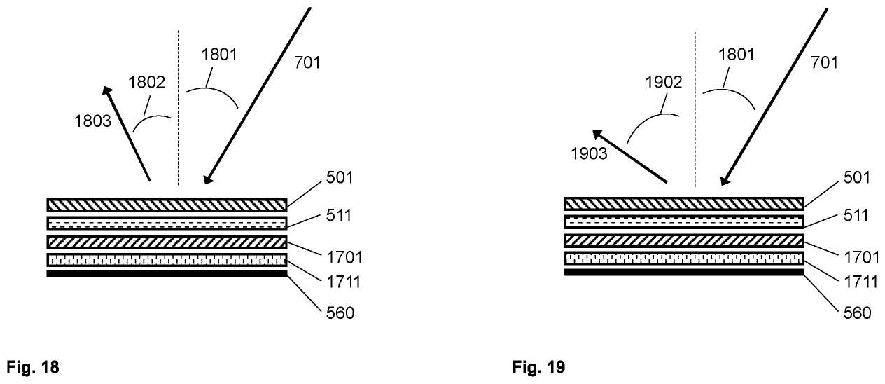

FIG. 17 illustrates an RD 500 configured to realize a two-dimensional beam steering for two different polarizations independently. The RD 500 comprises four sheets, a first sheet 501 movable in a horizontal first direction 508, a second sheet 511 movable in a horizontal second direction 518, a third sheet 1701 movable in a vertical third direction 1708, and a fourth sheet 1711 movable in a vertical fourth direction 1718. In an exposed area, corresponding sections of each of the sheets are stacked. RD 500 may comprise additionally a ground sheet in the exposed area. Corresponding actuators (not shown) are provided such that each of the four sheets can be moved independent of a movement of any of the other three sheets. As can be seen from the sectional views in FIGS. 18 to 21, the four sheets are stacked so that a radio wave incident on the exposed area passes through a respective section of the first sheet 501 placed in the exposed area, a respective section of the second sheet 511 placed in the exposed area, a respective section of the third sheet 1701 placed in the exposed area, a respective section of the fourth sheet 1708 placed in the exposed area, and is reflected at the ground sheet 560.

For example, RD 500 may be configured to provide a polarization dependent beam steering with respect to a first polarization and a second polarization in an azimuth plane and an elevation plane.

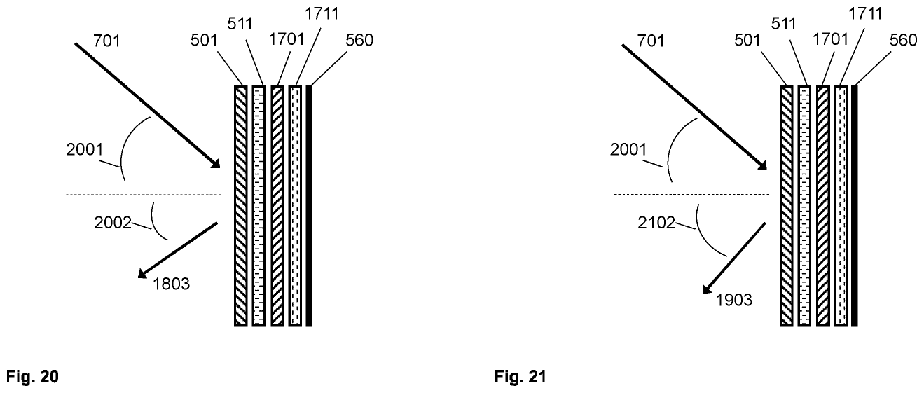

FIG. 18 and FIG. 19 each show a sectional view along sectional line 541 (see FIG. 17) of the four sheets 501, 511, 1708 and 1718, and ground sheet 560 in the exposed area. FIG. 20 and FIG. 21 each show a sectional view along sectional line 551 (see FIG. 17) of the four sheets 501, 511, 1708 and 1718, and ground sheet 560 in the exposed area.

An incident radio wave 701 has an incident azimuth angle 1801 and an incident elevation angle 2001. The incident radio wave 701 may comprise components of different polarizations. For example, the incident radio wave 701 may comprise a first component having the first polarization, for example a horizontal polarization, and may comprise a second component having the second polarization, for example a vertical polarization. The horizontal and vertical polarizations are examples only, and the incident radio wave 701 may comprise other kinds of polarizations, for example right circular polarization and left circular polarization. The first and second polarizations may be orthogonal to each other.

The first sheet 501 is responsive to the first polarization only, i.e. the first sheet 501 only changes the phase of a radio wave or a component of a radio wave having the first polarization. The first sheet 501 may be transparent to radio waves or components of radio waves having other polarizations than the first polarization. When a radio wave passes through the first sheet 501, the spatial propagation properties of the radio wave are modified by the characteristics of the first sheet 501, i.e. the azimuth angle is modified. The first sheet 501 does not alter the spatial propagation properties of the radio wave in the elevation domain such that the first sheet 501 is essentially transparent for the vertical elevation component of the radio wave. As a result, the first sheet 501 influences only the azimuth angle of a radio wave or a component of a radio wave having the first polarization.

The second sheet 511 is responsive to the second polarization only, i.e. the second sheet 511 only changes the phase of a radio wave or a component of a radio wave having the second polarization. The second sheet 511 may be transparent to radio waves or components of radio waves having other polarizations than the second polarization. When a radio wave passes through the second sheet 511, the spatial propagation properties of the radio wave are modified by the characteristics of the second sheet 511, i.e. the azimuth angle is modified. The second sheet 511 does not alter the spatial propagation properties of the radio wave in the elevation domain such that the second sheet 511 is essentially transparent for the vertical elevation component of the radio wave. As a result, the second sheet 511 influences only the azimuth angle of a radio wave or a component of a radio wave having the second polarization.

The third sheet 1701 is responsive to the first polarization only, i.e. the third sheet 1701 only changes the phase of a radio wave or a component of a radio wave having the first polarization. The third sheet 1701 may be transparent to radio waves or components of radio waves having other polarizations than the first polarization. When a radio wave passes through the third sheet 1701, the spatial propagation properties of the radio wave are modified by the characteristics of the third sheet 1701, i.e. the elevation angle is modified. The third sheet 1701 does not alter the spatial propagation properties of the radio wave in the azimuth domain such that the third sheet 1701 is essentially transparent for the horizontal azimuth component of the radio wave. As a result, the third sheet 1701 influences only the elevation angle of a radio wave or a component of a radio wave having the first polarization.

The fourth sheet 1711 is responsive to the second polarization only, i.e. the fourth sheet 1711 only changes the phase of a radio wave or a component of a radio wave having the second polarization. The fourth sheet 1711 may be transparent to radio waves or components of radio waves having other polarizations than the second polarization. When a radio wave passes through the fourth sheet 1711, the spatial propagation properties of the radio wave are modified by the characteristics of the fourth sheet 1711, i.e. the elevation angle is modified. The fourth sheet 1711 does not alter the spatial propagation properties of the radio wave in the azimuth domain such that the fourth sheet 1711 is essentially transparent for the horizontal azimuth component of the radio wave. As a result, the fourth sheet 1711 influences only the elevation angle of a radio wave or a component of a radio wave having the second polarization.

The thus modified radio wave is reflected at the ground sheet 560. When traveling from the ground sheet 560 through the four sheets 1711, 1701, 511 and 501, the radio wave may be modified once more according to the characteristics of the sheets. As the spatial propagation direction of the component of the radio wave having the first polarization may have been modified different from the spatial propagation direction of the component of the radio wave having the second polarization, the outgoing radio wave may be considered as two outgoing radio waves or two components of a radio wave, e.g. a first outgoing radio wave 1803 having the first polarization, and a second outgoing wave 1903 having the second polarization. The first outgoing radio wave 1803 has an exit azimuth angle 1802 and an exit elevation angle 2002. The second outgoing radio wave 1903 has an exit azimuth angle 1902 and an exit elevation angle 2102. When moving the first sheet 501 such that the characteristics vary, only exit azimuth angle 1802 changes, and exit azimuth angle 1902 and exit elevation angles 2002 and 2102 remain unchanged. Likewise, when moving the second sheet 511 such that the characteristics vary, the exit azimuth angle 1902 changes, and exit azimuth angle 1802 and exit elevation angles 2002 and 2102 remain unchanged; when moving the third sheet 1701 such that the characteristics vary, the exit elevation angle 2002 changes, and exit azimuth angles 1802 and 1902, and exit elevation angle 2102 remain unchanged; when moving the fourth sheet 1711 such that the characteristics vary, the exit elevation angle 2102 changes, and exit azimuth angles 1802 and 1902, and exit elevation angle 2002 remain unchanged.

It is to be noticed that sheets 501 and 1701 are transparent to signals with the second polarization, and vice versa sheets 511 and 1711 are transparent to signals with the first polarization. The phase changes incurred by the first sheet 501 and the third sheet 1701 may be combined additively and the phase changes incurred by the second sheet 511 and the fourth sheet 1711 may be combined additively, so that the design decouples into independent azimuth- and elevation-plane designs.

For designing patterns and structures of the four sheets 501, 511, 1701 and 1711, the following aspects based on the above description of RDs 500 of FIGS. 5 and 14 may be considered.

FIG. 14 illustrates unit cells that are responsive to the specific polarization only, for example using orthogonally placed dipole unit cells on sheets for influencing a specific polarization only. As shown in connection with RD 500 of FIGS. 5 and 13, the elevation influencing sheets 1701 and 1711 may introduce a phase difference along the vertical direction. This may be accomplished with a metasurface (see first example 1302 of FIG. 13) or a dielectric substrate (see example second example 1303 of FIG. 13). However, the elevation influencing sheets 1701 and 1711 may also need to respond to only one polarization without affecting the other one. In particular, this may be accomplished by implementing them with metasurfaces that also comprise horizontal/vertical dipoles as the first and second sheets 501 and 511. The orientation of the dipole elements on the third sheet 1701 may be the same as the orientation of the dipole elements on the first sheet 501. The orientation of the dipole elements on the fourth sheet 1711 may be the same as the orientation of the dipole elements on the second sheet 511.

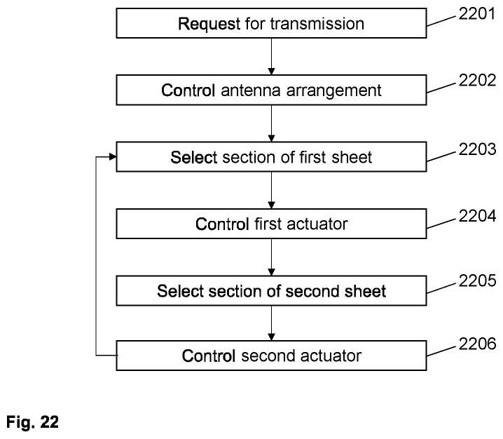

FIG. 22 shows method steps for operating an RD in a wireless communication system. In the following, operating an RD with two sheets will be described in more detail. However, the same techniques and principles may be applied to operating an RD with more than two sheets, for example operating an RD with four sheets as shown in FIG. 17.

According to the method, a request for a transmission between an access device and a TD may be determined in step 2201. For example a request for a transmission between BS 101 and TD 102 of FIG. 2 may be determined. In response to this request, in step 2202 the access device, for example BS 101, may control its antenna arrangement, e.g. antenna arrangement 1011, to direct a beam of electromagnetic waves, for example beam 203, to the RD, for example RD 500. Next, the RD may be configured to reflect the incident beam to the TD, for example, RD 500 may reflect incident beam 203 as reflected beam 204 to TD 102. RD 500 may have the structure as described in connection with FIG. 5. For example, in step 2203 an appropriate section of the first sheet 501 of RD 500 may be selected to adjust the azimuth propagation direction of the reflected beam 204. In step 2204 the first sheet 501 may be moved such that the selected section is in the exposed area. In step 2205 an appropriate section of the second sheet 511 of RD 500 may be selected to adjust the elevation propagation direction of the reflected beam 204. In step 2206 the second sheet 511 may be moved such that the selected section is in the exposed area. For selecting the appropriate sections of the first and second sheets 501 and 511, a position of the TD 102 may be considered. In other examples, a beam sweeping may be performed by moving the first and second sheets 501 and 511 in a coordinated way to scan systematically a certain area in which the TD 102 is expected to be. Based on a feedback from TD 102, the appropriate sections of the first and second sheets 501 and 511 may be determined.

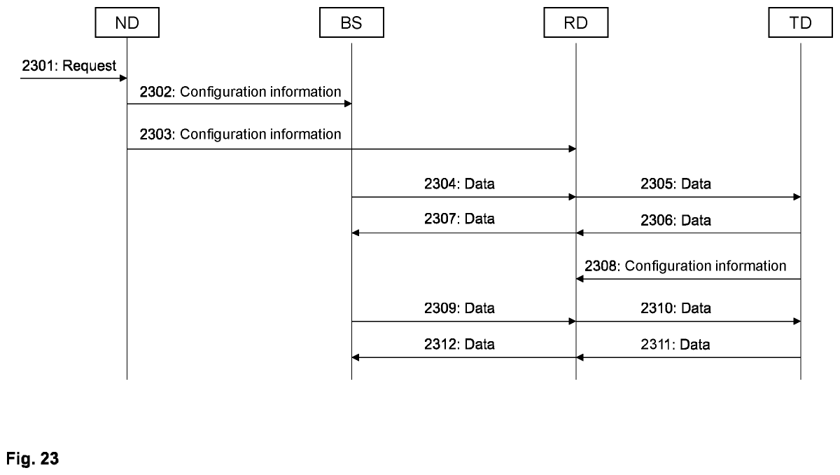

FIG. 23 shows a signal diagram illustrating signaling between a network device ND, a base station BS, a reconfigurable device RD and a terminal device TD. The ND may be part of the network management 104, for example a device of a control plane. The ND may receive a request 2301 for a transmission between the BS and the TD. In response to the request 2301, the ND transmits configuration information 2302 to the BS which instructs the BS to configure its antenna array to direct a beam in the direction of the RD. Furthermore, the ND may transmit configuration information 2303 to the RD instructing the RD to provide appropriate sections of the plurality of sheets of the RD which provide a redirection of a radio wave beam from the BS to the TD. The RD may comprise for example the RD as described above in connection with FIG. 5, 14 or 17. Once the antenna array of the BS and the RD are configured, a data signal 2304 may be transmitted from the BS to the RD and redirected at the reconfigurable device RD to the terminal device TD as data signal 2305. In the opposite direction, a data signal 2306 may be transmitted from the TD to the RD and redirected at the RD as data signal 2307 to the BS. The TD may also transmit configuration information 2308 to the RD. For example, when the TD is moving, it may communicate in the configuration information 2308 its new position to the RD. In response to this configuration information 2308, the RD may move appropriate sections of its sheets into the exposed area based on the new position of the TD. Further data may be communicated between the BS and the TD in a data signal 2309 transmitted from the BS to the RD and redirected at the RD as data signal 2310 to the TD. In the reverse direction, a data signal 2311 transmitted from the TD to the RD is redirected at the RD as data signal 2312 to the BS.

1. A reconfigurable device for influencing spatial properties of an incident radio wave, comprising:
a first sheet having characteristics that vary along a first length direction of the first sheet, the characteristics relating to a first influencing of a spatial propagation of an incident radio wave,
a second sheet having characteristics that vary along a second length direction of the second sheet, the characteristics relating to a second influencing of a spatial propagation of an incident radio wave,
a first actuator coupled to the first sheet and configured to move the first sheet along the first length direction so as to selectively place a section of the first sheet in an exposed area of the reconfigurable device,
a second actuator coupled to the second sheet and configured to move the second sheet along the second length direction so as to selectively place a section of the second sheet in the exposed area,
wherein the first sheet and the second sheet are stacked so that a radio wave incident on the exposed area passes through the respective section of the first sheet placed in the exposed area and is incident upon the respective section of the second sheet placed in the exposed area.

2. The reconfigurable device of claim 1, wherein the section of the first sheet placed in the exposed area, extends in a plane, while at least one further section in the first length direction of the first sheet is in a stowed position.

3. The reconfigurable device of claim 1, wherein the section of the second sheet placed in the exposed area, extends in a plane, while at least one further section in the second direction of the second sheet is in a stowed position.

4. The reconfigurable device of claim 1, wherein the first actuator comprises at least one elongated roller which is configured to rotate around its longitudinal axis for rolling and unrolling at least a section of the first sheet.

5. The reconfigurable device of claim 1, wherein the second actuator comprises at least one elongated roller which is configured to rotate around its longitudinal axis for rolling and unrolling at least a section of the second sheet.

6. The reconfigurable device of claim 1, wherein the first length direction is perpendicular to the second length direction.

7. The reconfigurable device of claim 1, wherein the first length direction is parallel to the second length direction.

8. The reconfigurable device of claim 1, further comprising a ground sheet placed in the exposed area, wherein the first sheet, the second sheet and the ground sheet are stacked so that a radio wave incident on the exposed area passes through the respective section of the first sheet placed in the exposed area and the respective section of the second sheet placed in the exposed area and is reflected at the ground sheet.

9. The reconfigurable device of claim 8, wherein the ground sheet is separate from the first sheet and the second sheet.

10. The reconfigurable device of claim 8, wherein the ground sheet is integrated into the second sheet.

11. The reconfigurable device of claim 1, wherein the characteristics that vary along the length direction of the corresponding sheet are formed by at least one of:
varying a thickness of the corresponding sheet,
varying an amount of a dielectric material in the corresponding sheet,
varying a type of a dielectric material in the corresponding sheet,
varying an amount of a conductive material in the corresponding sheet,
varying a type of a conductive material in the corresponding sheet,
varying a conductive structure of a conductive material in the corresponding sheet.

12. The reconfigurable device of claim 1, wherein the characteristics that vary along the first and second length direction are configured to influence the spatial propagation of the incident radio wave by at least one of refraction and diffraction.

13. The reconfigurable device of claim 1, wherein the characteristics that vary along the first and second length directions are configured to implement a corresponding phase response and amplitude response for beam steering of the radio wave.

14. The reconfigurable device of claim 1, wherein the characteristics that vary along the first length direction are configured to implement a beam steering in a first plane of incidence for the radio wave, and wherein the characteristics that vary along the second length direction are configured to implement a beam steering in a second plane of incidence different from the first plane of incidence for the radio wave.

15. The reconfigurable device of claim 1,
wherein at least some sections in the first length direction of the first sheet are configured to implement a beam steering for a portion of a radio wave having a first polarization and to leave unaffected a remaining portion of the radio wave having a polarization different from the first polarization, and
wherein at least some sections in the second length direction of the second sheet are configured to implement a beam steering for a portion of the radio wave having a second polarization different from the first polarization.

16. The reconfigurable device of claim 1, further comprising:
a third sheet having characteristics that vary along a third length direction of the third sheet, the characteristics relating to a third influencing of a spatial propagation of an incident radio wave,
a fourth sheet having characteristics that vary along a fourth length direction of the fourth sheet, the characteristics relating to a fourth influencing of a spatial propagation of an incident radio wave,
a third actuator coupled to the third sheet and configured to move the third sheet along the third length direction so as to selectively place a section of the third sheet in the exposed area,
a fourth actuator coupled to the fourth sheet and configured to move the fourth sheet along the fourth length direction so as to selectively place a section of the fourth sheet in the exposed area,
wherein the first sheet, the second sheet, the third sheet and the fourth sheet are stacked so that a radio wave incident on the exposed area passes through the respective section of the first sheet placed in the exposed area, the respective section of the second sheet placed in the exposed area, the respective section of the third sheet placed in the exposed area, and is incident upon the respective section of the fourth sheet placed in the exposed area.

17. The reconfigurable device of claim 16,
wherein at least some sections in the first length direction of the first sheet are configured to implement a beam steering in a first plane of incidence for a portion of the radio wave having a first polarization and to pass unaffected a remaining portion of the radio wave having a polarization different from the first polarization,
wherein at least some sections in the second length direction of the second sheet are configured to implement a beam steering in the first plane of incidence for a portion of the radio wave having a second polarization different from the first polarization and to pass unaffected a remaining portion of the radio wave having a polarization different from the second polarization,
wherein at least some sections in the third length direction of the third sheet are configured to implement a beam steering in a second plane of incidence different from the first plane of incidence for a portion of the radio wave having the first polarization and to pass unaffected a remaining portion of the radio wave having a polarization different from the first polarization, and
wherein at least some sections in the fourth length direction of the fourth sheet are configured to implement a beam steering in the second plane of incidence for a portion of the radio wave having the second polarization.

18. The reconfigurable device of claim 1, wherein at least one of the first and second sheets comprises a flexible material, preferably comprising at least one of plastics, rubber, semiconductor material, graphene and fibers.

19. The reconfigurable device of claim 1, further comprising an interface for receiving control information from a network device of a wireless communication system for controlling at least one of the first and second actuators.

20. The reconfigurable device of claim 1, further comprising a wireless interface for receiving control information from a terminal device operated in a wireless communication system for controlling at least one of the first and second actuators.

21-24. (canceled)
